(19) United States
(12) Patent Application Publication
(10) Pub. No.: US 2019/0188139 A1
(43) Pub. Date: Jun. 20, 2019

(54) ARITHMETIC PROCESSING UNIT, MEMORY ACCESS CONTROLLER, AND METHOD FOR CONTROLLING ARITHMETIC PROCESSING UNIT

(71) Applicant: FUJITSU LIMITED, Kawasaki-shi (JP)

(72) Inventor: Kodai MORITAKA, Kawasaki (JP)

(73) Assignee: FUJITSU LIMITED, Kawasaki-shi (JP)

(21) Appl. No.: 16/199,294

(22) Filed: Nov. 26, 2018

(30) Foreign Application Priority Data
Dec. 19, 2017 (JP) 2017-242531

(51) Int. Cl. G06F 12/0844

(52) U.S. Cl. CPC G06F 12/0844; G06F 2212/1016

(57) ABSTRACT

An arithmetic processing unit includes a processing unit, a cache control unit that issues a request for the memory access, and a memory access controller that includes a request queue, and a request selection unit which selects a request from among requests enqueued in the request queue and issues the selected request to a memory. After issue of a previous request in the request queue, the request selection unit inhibits, during an issue inhibition period corresponding to the issued previous request, issue of a subsequent request corresponding to the issue inhibition period, and the request selection unit issues a second request in preference to a first request in a case where the requests in the request queue are in a first state, the first request being one of a read request and a write request in the request queue, and the second request being a request in the request queue.

### CROSS-REFERENCE TO RELATED APPLICATION

This application is based upon and claims the benefit of priority of the prior Japanese Patent Application No. 2017-242531, filed on Dec. 19, 2017, the entire contents of which are incorporated herein by reference.

### FIELD

The present invention relates to an arithmetic processing unit, a memory access controller, and a method for controlling an arithmetic processing unit.

### BACKGROUND

An arithmetic processing unit is a central processor unit (CPU) or a processor (chip). The processor includes an arithmetic processing unit (CPU core, Core) that executes an instruction, a cache unit, and a memory access controller.

The cache unit includes a cache memory, and a cache control unit that makes a cache hit determination of whether or not data of an access destination address is stored in the cache memory in response to a memory access request (first memory access request) issued by the CPU core, and sends back the data in the cache memory when a cache hit is detected.

When a cache miss is detected, the cache control unit issues another memory access request (second memory access request) to the memory access controller. The memory access controller issues a read command or a write command to a memory in response to the memory access request from the cache control unit to access the data at the access destination address in the memory. The memory access controller is provided in the processor chip. Alternatively, the memory access controller may be constituted by another chip different from the processor chip.

A memory access controller is disclosed in Japanese Laid-open Patent Publication No. 2013-206474 and Japanese Laid-open Patent Publication No. 2003-248622.

### SUMMARY

The memory access controller (hereinafter referred to as a MAC) includes a buffer called a request queue that stores the memory access request from the cache control unit. The MAC selects one of the memory access requests enqueued in the request queue based on a request issue penalty (hereinafter simply referred to as a penalty). The penalty is an issue inhibition period of a subsequent request that is to be set between a previous request and the subsequent request and is specified in specifications of the memory. And the MAC issues a command corresponding to the selected request to the memory. The command is a combination of signals for transmitting the memory access request to the memory using a protocol corresponding to the specifications of the memory. Consequently, the command is substantially equivalent to the memory access request.

The above penalty is specified based on the specifications of the memory. The penalty is usually short in the case where the type (read or write) of the subsequent request is the same as that of the previous request, and is long in the case where the type of the subsequent request is different from that of the previous request. In addition, the penalty is short in the case where the address of the subsequent request is different from that of the previous request, and is long in the case where the address of the subsequent request is the same as that of the previous request. With such specifications of the penalty, after the previous request is issued, when the request of the same type as the previous request is enqueued during the long penalty period of the subsequent request of a different type from the previous request, the MAC selects the request of the same type as the previous request.

However, when the MAC selects the memory access request in the request queue based on the above penalty and issues the command to the memory, there are cases where the memory access requests of the same type (read or write) are consecutively issued. In addition, a problem arises in that even in the case where the frequency of issue of the memory access requests of the same type is reduced, the memory access request of a different type is not issued due to the restriction of the penalty, and request issue throughput is reduced.

According to an aspect of the embodiments, an arithmetic processing unit includes a processing unit; a cache control unit that, in respond to a memory access from the processing unit, issues a request for the memory access in a case where data of an access destination is not stored in a cache memory; and a memory access controller that includes a request queue in which the request is enqueued, and a request selection unit which selects a request from among requests enqueued in the request queue and issues the selected request to a memory, wherein after issue of a previous request in the request queue, the request selection unit inhibits, during an issue inhibition period corresponding to the issued previous request, issue of a subsequent request corresponding to the issue inhibition period, and the request selection unit issues a second request in preference to a first request in a case where the requests in the request queue are in a first state, the first request being one of a read request and a write request in the request queue, and the second request being a request in the request queue which is different from the first request.

According to the first aspect, it is possible to provide the MAC having improved request issue throughput.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the configuration of a processor.

FIG. 2 is a view for illustrating the summary of the penalty to the memory.

FIG. 3 is a view for illustrating an example in which the frequency of issue of the memory access request issued by the memory access controller is reduced.

FIG. 4 is a timing chart illustrating the example illustrated in FIG. 3 in which the frequency of issue of the memory access request is reduced.

FIG. 5 illustrates the configuration of the processor in a first embodiment.

FIG. 6 illustrates the configuration of the busy information generation circuit BSY_INF_GEN.

FIG. 7 illustrates a specific example of the preferential opcode generation circuit PR_OPCD_GEN.

FIG. 8 is a flowchart illustrating the operation logic of each of the read and write request counters RD_RQ_CNTR and WR_RQ_CNTR.

FIG. 9 is a flowchart illustrating the operation logic of each of the write request issue interval counter WR_ISS_INT_CNTR and the read request issue interval counter RD_ISS_INT_CNTR.

FIG. 10 is a flowchart illustrating the operation logic of the preferential opcode determination unit PR_OPCD_DET.

FIG. 11 illustrates an example of the request selection circuit controlled by the preferential opcode PR_OPCD.

FIG. 12 illustrates an example of the configuration of the busy information signal generation unit BSY_GEN in the busy information generation circuit BSY_INF_GEN.

FIG. 13 illustrates the entry determination unit 20_# and the busy signal selection circuit 35 of the request selection circuit.

FIG. 14 illustrates truth tables of the individual logic circuits of the entry determination unit 20_#.

FIG. 15 is a timing chart illustrating the operation of the entry determination unit 20_#.

FIG. 16 is a timing chart illustrating the operation of the entry determination unit 20_#.

FIG. 17 illustrates the configuration of the processor in a second embodiment.

FIG. 18 illustrates a flowchart illustrating the operation of the head entry timer circuit E0_TIMER.

FIG. 19 illustrates an example of the request selection circuit controlled by the head entry preferential signal in the second embodiment.

### DESCRIPTION OF EMBODIMENTS

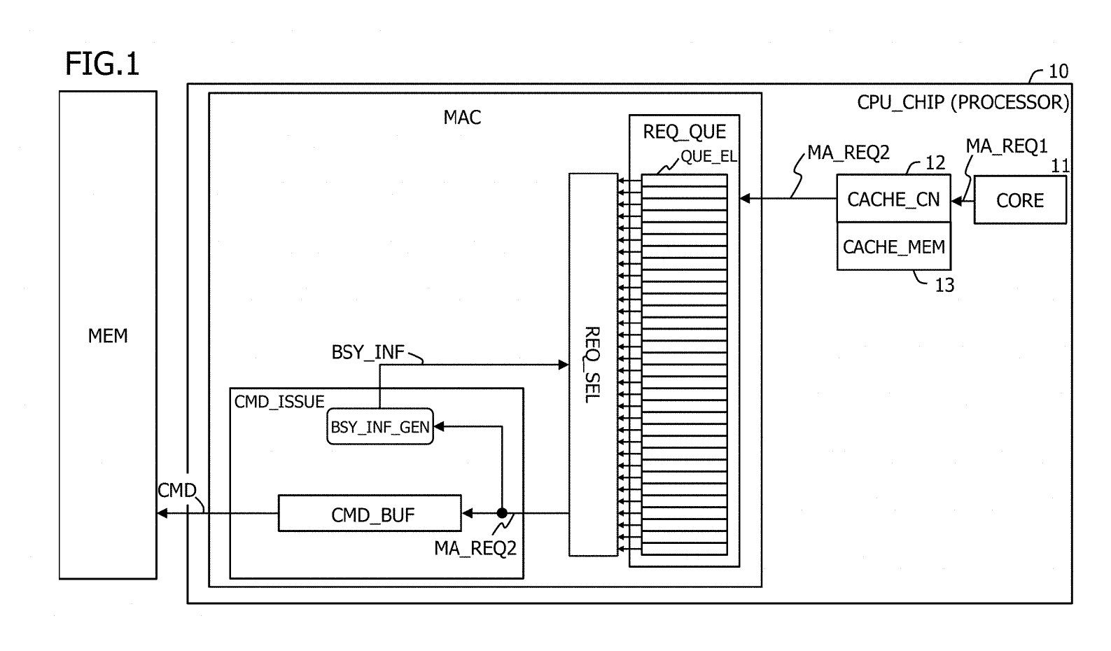

FIG. 1 illustrates the configuration of a processor. A processor 10 that is a CPU chip includes a core 11 that is an arithmetic processing unit that executes an instruction, a cache unit that includes a cache memory 13 and a cache control unit (circuit) 12 that controls the cache memory 13, and a memory access controller MAC that outputs a memory access command CMD to an external memory MEM.

When the cache control unit 12 receives a first memory access request MA_REQ1 issued by the core, the cache control unit 12 makes a cache hit determination of whether or not data of an access destination is stored in the cache memory 13. The cache control unit sends the data in the cache memory 13 to the core in the case where a cache hit is detected, and outputs a second memory access request MA_REQ2 to the memory access controller MAC in the case where a cache miss is detected.

The memory access controller MAC includes a request queue REQ_QUE in which the second memory access request MA_REQ2 output from the cache control unit is enqueued and accumulated, a request selection circuit REQ_SEL that selects one of the second memory access requests that wait in the request queue, and a command issue unit CMD_ISSUE that converts the selected memory access request to a command to a memory and issues the command.

The command issue unit CMD_ISSUE includes a command buffer CMD_BUF that temporarily accumulates the second memory access request MA_REQ2 selected and issued by the request selection circuit REQ_SEL and generates the command to be issued to a memory MEM. In addition, the command issue unit CMD_ISSUE includes a busy information generation circuit BSY_INF_GEN that monitors the memory access request MA_REQ2 issued by the request selection circuit or a command CMD issued by the command buffer CMD_BUF, and generates busy information BSY_INF for performing a control that inhibits issue during an issue inhibition period described later based on a request issue penalty of the memory MEM.

The request selection circuit REQ_SEL selects, based on the busy information BSY_INF, the memory access request MA_REQ2 of which penalty period has elapsed and that is enqueued earliest in the penalty period elapsed requests from among the requests accumulated in the request queue. This is a selection criterion of the request selection circuit.

The memory access request is broadly classified into a read request and a write request. The read request is the request for reading data at an access destination address from the memory MEM, and the write request is the request for writing data to the access destination address in the memory MEM. Consequently, the memory MEM executes different processes for a read request and a write request.

In the case where the memory MEM is, e.g., a dynamic random access memory (DRAM), the command CMD issued to the memory MEM includes a combination of an active command and a read command for the read, and includes a combination of the active command, and a write command with write data. In this case, the combination of the active command and the read command is issued to the memory for the read request. On the other hand, the combination of the active command and the write command is issued to the memory for the write request.

When the request selection circuit REQ_SEL selects the read or write request in the request queue and issues the selected request to the command issue unit CMD_ISSUE, the command issue unit issues the read or write command corresponding to the issued request. In the following description, the selection and issue of the request by the request selection circuit is referred to as the issue of the request by the request selection circuit for the sake of simplification. The issue of the request by the request selection circuit and the issue of the command corresponding to the request to the memory by the command issue unit occur substantially simultaneously when a slight difference in timing is ignored.

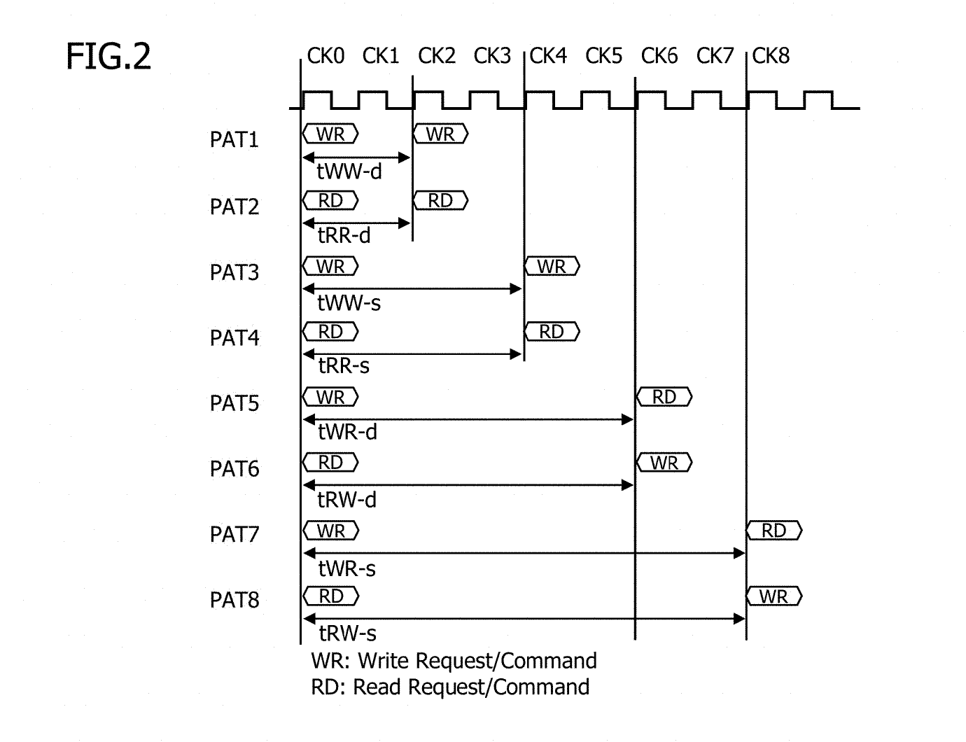

FIG. 2 is a view for illustrating the summary of the penalty to the memory. The memory MEM demands a system that issues the memory access request to set the issue inhibition period (penalty) in which, after a previous request is issued, the issue of a subsequent request is inhibited.

FIG. 2 illustrates an issue inhibition period tWW in the case where a subsequent write request WR is issued after the issue of a previous write request WR, an issue inhibition period tRR in the case where a subsequent read request RD is issued after a previous read request RD, an issue inhibition period tWR in the case where the subsequent read request RD is issued after the previous write request WR, and an issue inhibition period tRW in the case where the subsequent write request WR is issued after the previous read request RD. The individual issue inhibition periods have (1) issue inhibition periods tWW-d, tRR-d, tWR-d, and tRW-d in the case where the address of the subsequent request is different from that of the previous request, and have (2) issue inhibition periods tWW-s, tRR-s, tWR-s, and tRW-s in the case where the address of the subsequent request is the same as that of the previous request.

The length of each issue inhibition period illustrated in FIG. 2 is an example. In general, the issue inhibition periods tWR-d, tWR-s, tRW-d, and tRW-s each corresponding to different requests are longer than the issue inhibition periods tRR-d, tRR-s, tWW-d, and tWW-s each corresponding to the same requests. In addition, in the issue inhibition periods each corresponding to the same requests, the issue inhibition periods tWW-d and tRR-d each corresponding to different addresses are shorter than the issue inhibition periods tWW-s and tRR-s each corresponding to the same address. Similarly, in the issue inhibition periods each corresponding to different requests, the issue inhibition periods tWR-d and tRW-d each corresponding to different addresses are shorter than the issue inhibition periods tWR-s and tRW-s each corresponding to the same address. Consequently, in general, the following relationships between the lengths of the period are satisfied.

tWW<tWR

tRR<tRW

tWW-d<tWW-s

tRR-d<tRR-s

tWR-d<tWR-s

tRW-d<tRW-s

According to the example in FIG. 2, the following restrictions are imposed on the issue of the subsequent request by the request selection circuit.

(PAT1) In the case where the previous request is the write request, it is not possible to issue the write request having the different address as the subsequent request during the issue inhibition period tWW-d from the issue of the previous request.
(PAT2) In the case where the previous request is the read request, it is not possible to issue the read request having the different address as the subsequent request during the issue inhibition period tRR-d from the issue of the previous request.
(PAT3) In the case where the previous request is the write request, it is not possible to issue the write request having the same address as the subsequent request during the issue inhibition period tWW-s from the issue of the previous request.
(PAT4) In the case where the previous request is the read request, it is not possible to issue the read request having the same address as the subsequent request during the issue inhibition period tRR-s from the issue of the previous request.
(PAT5) In the case where the previous request is the write request, it is not possible to issue the read request having the different address during the issue inhibition period tWR-d from the issue of the previous request.
(PAT6) In the case where the previous request is the read request, it is not possible to issue the write request having the different address during the issue inhibition period tRW-d from the issue of the previous request.
(PAT7) In the case where the previous request is the write request, it is not possible to issue the read request having the same address during the issue inhibition period tWR-s from the issue of the previous request.
(PAT8) In the case where the previous request is the read request, it is not possible to issue the write request having the same address during the issue inhibition period tRW-s from the issue of the previous request.

The above eight patterns are obtained according to whether the previous request is the read request RD or the write request WR, according to whether the subsequent request is the read request RD or the write request WR, and according to whether the addresses of the previous request and the subsequent request are the same or are different from each other (2³=eight patterns), and each of the eight patterns has the issue inhibition period.

Returning to FIG. 1, the command issue unit CMD_ISSUE includes the busy information generation circuit BSY_INF_GEN that monitors the memory access request MA_REQ2 issued by the request selection circuit REQ_SEL or the command CMD issued by the command buffer CMD_BUF, and outputs the busy information BSY_INF to the request selection circuit REQ_SEL. An example of the busy information includes a busy signal that transitions to an L level during the above issue inhibition period. The busy information generation circuit selects four types of busy signals from eight types of busy signals based on an opcode (type, read or write) of the previous request, and outputs the selected busy signals as the busy information. The request selection circuit inhibits the selection of the request in the request queue during its issue inhibition period based on the busy information. Subsequently, the request selection circuit selects the request that is enqueued earliest from among the requests of which selection is not inhibited, and issues the selected request.

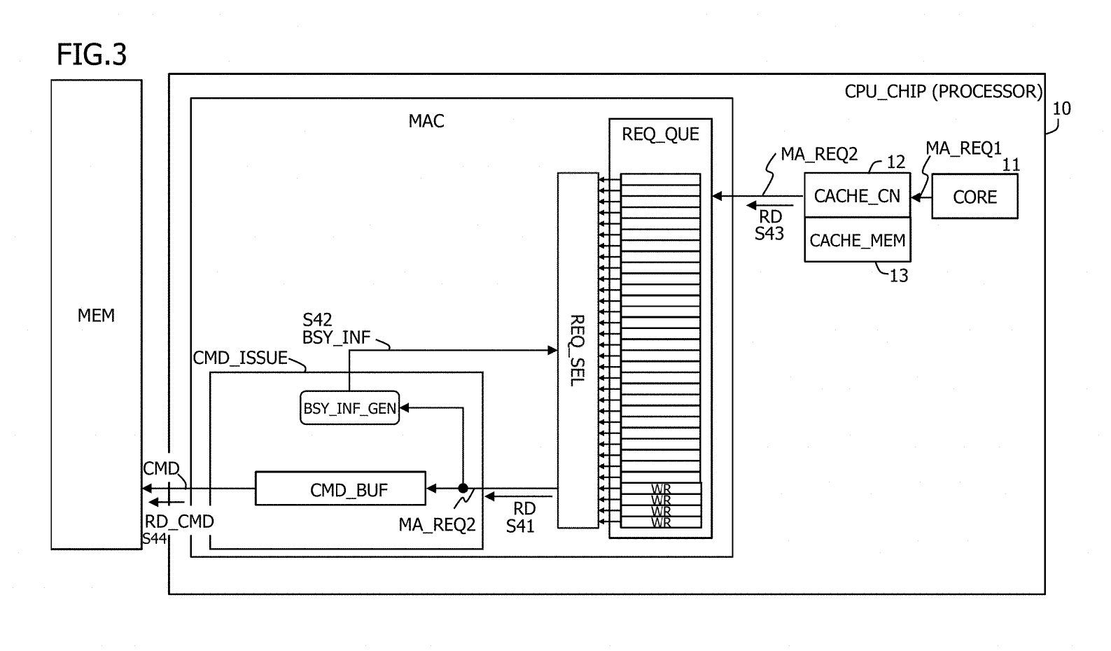

FIG. 3 is a view for illustrating an example in which the frequency of issue of the memory access request issued by the memory access controller is reduced. The operation in FIG. 3 is as follows.

First, the request selection circuit REQ_SEL selects the read request RD, and the command issue unit CMD_ISSUE issues the read command (S41). Subsequently, the busy information generation circuit outputs the busy information BSY_INF based on the selected or issued read request or command (S42).

Next, immediately before a lapse of the penalty tRW-s, the cache control unit CACHE_CN issues the read request RD as the second memory access request, and enqueues the read request RD in the request queue REQ_QUE (S43). In response to this, the request selection circuit REQ_SEL selects the read request RD enqueued in the request queue REQ_QUE in preference to the write request WR in the request queue REQ_QUE (S43). Subsequently, the command issue unit CMD_ISSUE issues a read command RD_CMD corresponding to the selected read request (S44).

As a result, a plurality of the write requests WR that are not issued remain in the request queue REQ_QUE without being selected.

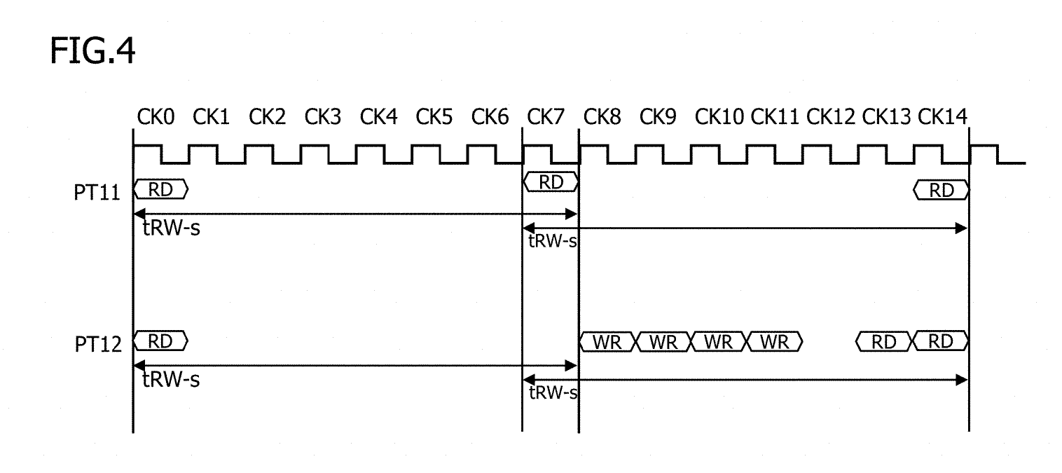

FIG. 4 is a timing chart illustrating the example illustrated in FIG. 3 in which the frequency of issue of the memory access request is reduced. A pattern PT11 in FIG. 4 corresponds to the example in which the frequency of issue of the request is reduced.

In the pattern PT11, the read request RD is issued at a clock CK0, the read request RD is enqueued in the request queue immediately before the lapse of the issue inhibition period tRW-s serving as the penalty, and the subsequent read request RD is issued at a clock CK7 immediately before the lapse of the issue inhibition period tRW-s. The similar operation is repeated again, and the subsequent read request RD is issued again at a clock CK14.

As a result of repetition of the above operation, the intermittently enqueued read requests are consecutively issued in preference to the write requests WR remaining in the request queue REQ_QUE due to the penalty, and request issue throughput is reduced.

As illustrated in FIG. 3, even when a large number of the write requests WR are present in the request queue REQ_QUE, the read request RD is preferentially issued due to the penalty to the subsequent request having the same address as that of the previous request, and a situation in which the write request WR is not issued continues for a long time period. This is one of the states in which the frequency of issue of the request is reduced.

The frequency of issue of the request denotes the number of requests (commands) issued by the memory access controller on a per unit time.

The reduction of the frequency of issue in the pattern PT11 illustrated in FIG. 4 also occurs when the read request RD and the write request WR change places.

### First Embodiment

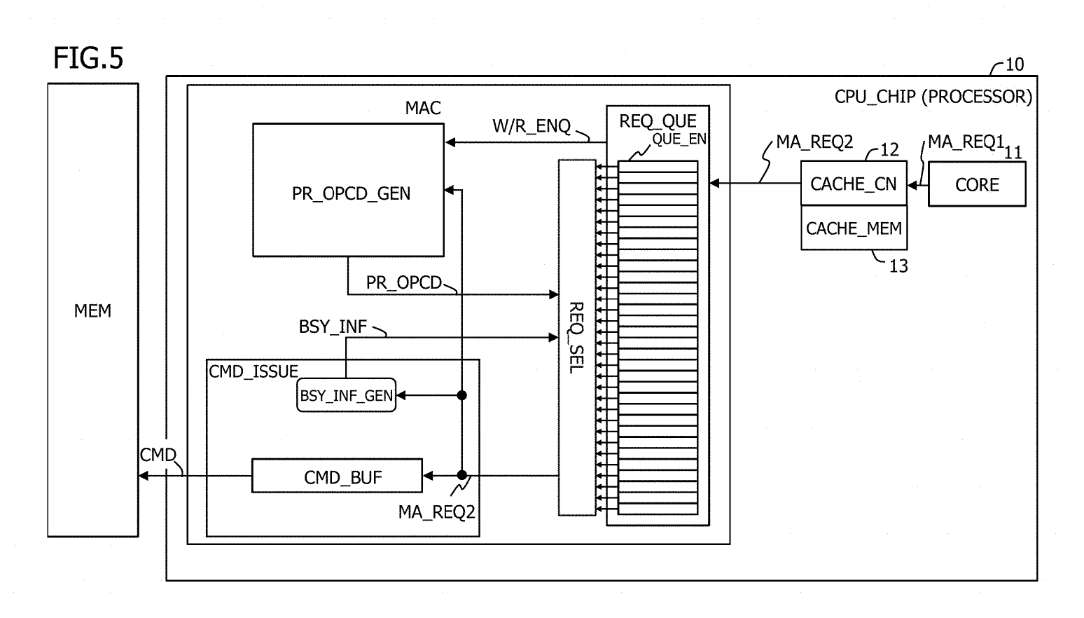

FIG. 5 illustrates the configuration of the processor in a first embodiment. In addition to the configuration in FIG. 1, the memory access controller MAC in the processor 10 in FIG. 5 includes a preferential opcode generation circuit PR_OPCD_GEN. The preferential opcode generation circuit PR_OPCD_GEN generates a preferential opcode PR_OPCD. Further, in the memory access controller MAC in FIG. 5, the request selection circuit REQ_SEL selects and issues the request in the request queue based on request selection logic based on the preferential opcode PR_OPCD in addition to request selection logic based on the busy information BSY_INF.

Preferential Opcode Generation Circuit PR_OPCD_GEN

The preferential opcode generation circuit PR_OPCD_GEN monitors the request enqueued in the request queue REQ_QUE by using request information W/R_ENQ to monitor whether or not one of the number of read requests present in the request queue and the number of write requests present therein satisfies a predetermined condition. An example of the predetermined condition includes whether or not one of the number of read requests present in the request queue and the number of write requests present therein is more than a reference number, whether or not a difference between the number of read requests present in the request queue and the number of write requests present therein is more than a threshold value, or whether or not, among read requests and write requests present in the request queue, the number of first requests is more than an upper limit value and the number of second requests different from the first requests is less than a lower limit value.

Further, the preferential opcode generation circuit PR_OPCD_GEN monitors the second memory access request MA_REQ2 selected and issued by the request selection circuit or the command CMD issued by the command buffer CMD_BUF to monitor whether or not the frequency of issue of the read request or the write request is less than a reference frequency, or whether or not an issue interval is not less than a reference interval.

When the preferential opcode generation circuit PR_OPCD_GEN detects a situation like the pattern PT11 illustrated in FIG. 4 based on the above monitoring, the preferential opcode generation circuit PR_OPCD_GEN outputs the preferential opcode PR_OPCD that gives preference to the write request WR of which issue is inhibited. Subsequently, the request selection circuit REQ_SEL inhibits the issue of the read request Rd that is different from the write request WR set in the preferential opcode PR_OPCD. As a result, the request selection circuit inhibits the issue of the request (RD) other than the request (WR) set in the preferential opcode during a preferential period including the penalty period, and issues one of the requests (WR) specified by the preferential opcode that is enqueued earliest and of which issue is inhibited by the penalty after the lapse of the penalty period. This enables avoidance of continuous inhibition of the issue of one of the read request and the write request caused by the consecutive issue of the other of the read request and the write request, and the reduction of the request issue throughput can be prevented.

Unlike the pattern PT11 in FIG. 4, in the case where the read request (RD) is set in the preferential opcode PR_OPCD, the request selection circuit REQ_SEL inhibits the issue of the write request (WR) during the preferential period including the penalty period. As a result, the request selection circuit issues one of the read requests (RD) specified by the preferential opcode that is enqueued earliest after the lapse of the penalty period.

Busy Information Generation Circuit BSY_INF_GEN

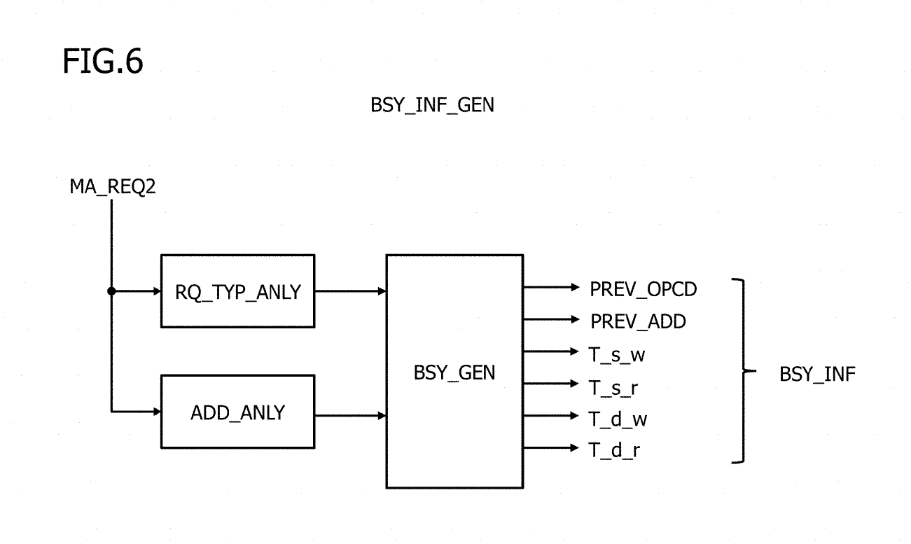

FIG. 6 illustrates the configuration of the busy information generation circuit BSY_INF_GEN. As illustrated in FIG. 5, the busy information generation circuit receives the second memory access request MA_REQ2 selected and issued by the request selection circuit REQ_SEL. The busy information generation circuit includes a request type analysis unit RQ_TYP_ANLY that determines the request type indicative of the read or the write included in the second memory access request MA_REQ2, an address extraction unit ADD_ANLY that extracts the address, and a busy information signal generation unit BSY_GEN that generates the busy information BSY_INF from the request type and the address.

The busy information signal generation unit BSY_GEN generates, e.g., the following pieces of the busy information BSY_INF.

(A1) four busy signals T_s_w, T_s_r, T_d_w, and T_d_r corresponding to a previous request opcode PREV_OPCD
(A2) a previous address PREV_ADD of the previous request
(A3) the previous request opcode PREV_OPCD

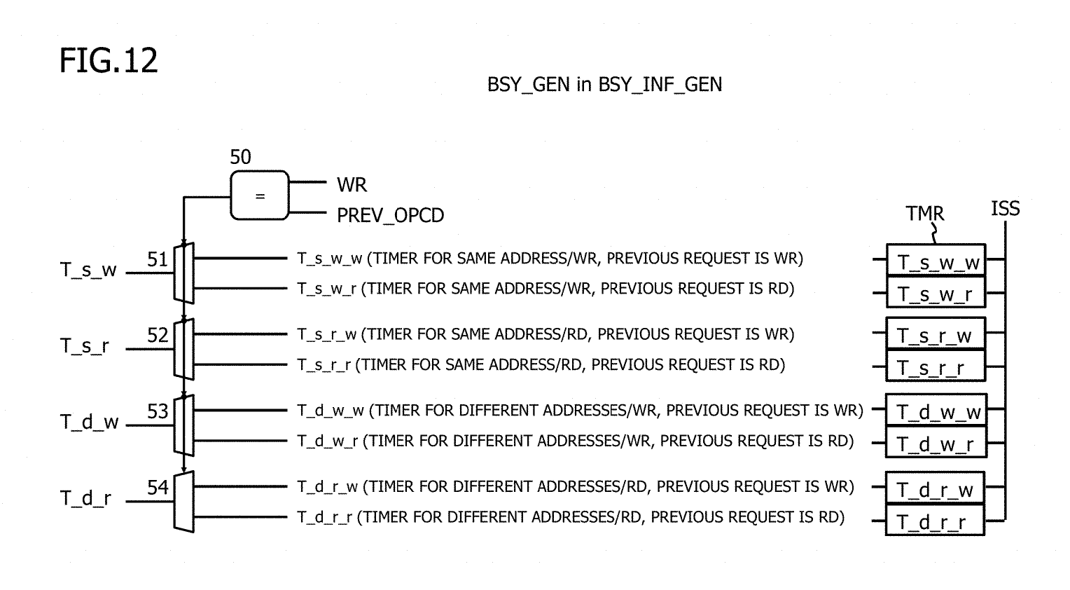

The busy signals and the busy information signal generation unit BSY_GEN described above will be described in detail in FIG. 12.

Specific Example of Preferential Opcode Generation Circuit PR_OPCD_GEN

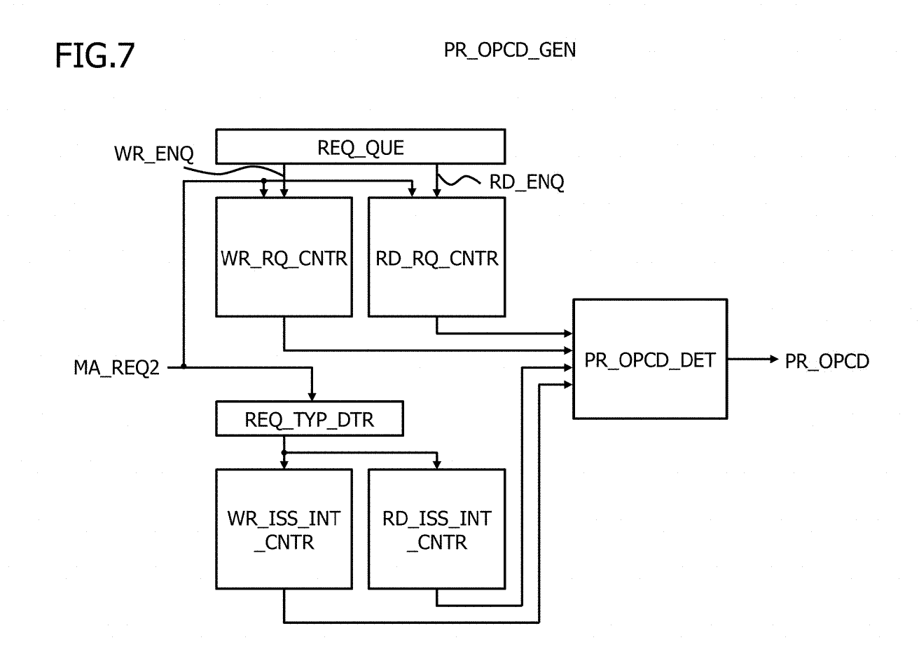

FIG. 7 illustrate a specific example of the preferential opcode generation circuit PR_OPCD_GEN. The preferential opcode generation circuit PR_OPCD_GEN generates the preferential opcode PR_OPCD for the request that is preferentially issued, i.e., of which issue is not inhibited. The opcode OPCD indicates the read request or the write request.

The preferential opcode generation circuit PR_OPCD_GEN includes a read request counter RD_RQ_CNTR that counts the number of read requests in the request queue REQ_QUE based on a read enqueue RD_ENQ output by the request queue REQ_QUE and the second memory access request MA_REQ2 issued by the request selection circuit, and a write request counter WR_RQ_CNTR that counts the number of write requests in the request queue REQ_QUE based on a write enqueue WR_ENQ output by the request queue REQ_QUE and the second memory access request MA_REQ2 issued by the request selection circuit.

Further, the preferential opcode generation circuit PR_OPCD_GEN includes a request type determination unit REQ_TYP_DTR that determines the request type of the request MA_REQ2 issued by the request selection circuit, a write request issue interval counter WR_ISS_INT_CNTR that counts the issue intervals of the write request, and a read request issue interval counter RD_ISS_INT_CNTR that counts the issue intervals of the read request.

In addition, the preferential opcode generation circuit PR_OPCD_GEN includes a preferential opcode determination unit PR_OPCD_DET that determines the preferential opcode PR_OPCD based on the above count values.

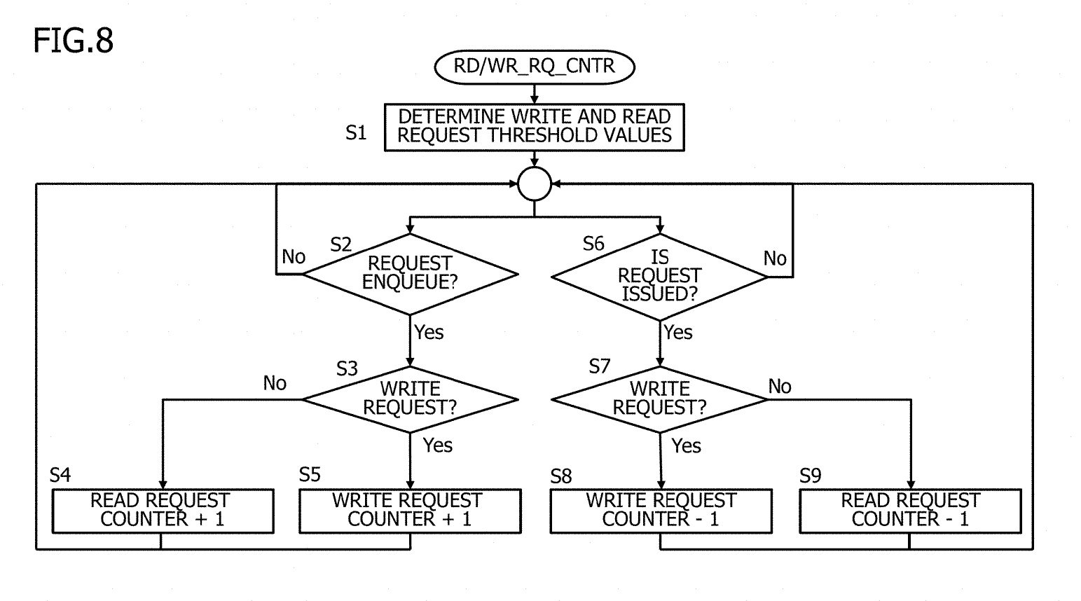

FIG. 8 is a flowchart illustrating the operation logic of each of the read and write request counters RD_RQ_CNTR and WR_RQ_CNTR. First, the read and write request counters determine threshold values of the number of the write request and the number of the read request (S1). The threshold values include the upper limit threshold value and the lower limit threshold value of the number of write requests in the request queue and the upper limit threshold value and the lower limit threshold value of the number of read requests in the request queue. Therese threshold values are referenced in the preferential opcode determination unit PR_OPCD_DET described later.

Next, when the request enqueue occurs (YES in S2), the write request counter increments the count number (S5) in the case where the request enqueue indicates the write request (YES in S3), and the read request counter increments the count number (S4) in the case where the request enqueue indicates the read request (NO in S3). When the request selection circuit issues the request (YES in S6), the write request counter decrements the count number (S8) in the case where the issued request is the write request (YES in S7), and the read request counter decrements the count number (S9) in the case where the issued request is the read request (NO in S7).

With this, the read and write request counters output the number of read requests present in the request queue and the number of write requests present in the request queue.

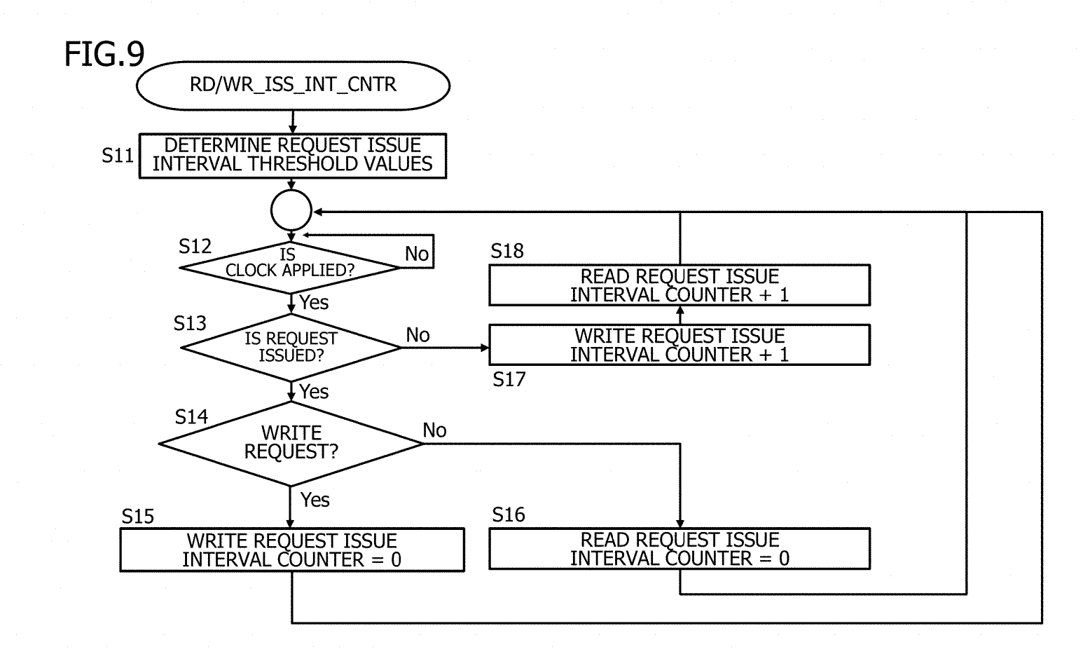

FIG. 9 is a flowchart illustrating the operation logic of each of the write request issue interval counter WR_ISS_INT_CNTR and the read request issue interval counter RD_ISS_INT_CNTR. First, the write and read request issue interval counters determine write and read request issue interval threshold values (S11). These threshold values are referenced in the preferential opcode determination unit PR_OPCD_DET described later.

Next, the write and read request issue interval counters execute the following processes every time a clock is applied to each counter (YES in S12). That is, when the request is issued (YES in S13), according to whether the issued request is the write request or the read request (S14), the write or read request issue interval counter resets the corresponding write or read request issue interval counter, and sets the counter value to 0 (S15, S16).

Subsequently, the write and read request issue interval counters increment the write and read request issue interval counters (S17, S18) every time the clock is applied to each counter (YES in S12) until the next request is issued (YES in S13). Since the increment is repeated until the next request is issued, the write and read request issue interval counters keep clock frequencies corresponding to the issue interval of the write request and the issue interval of the read request until the next request is issued.

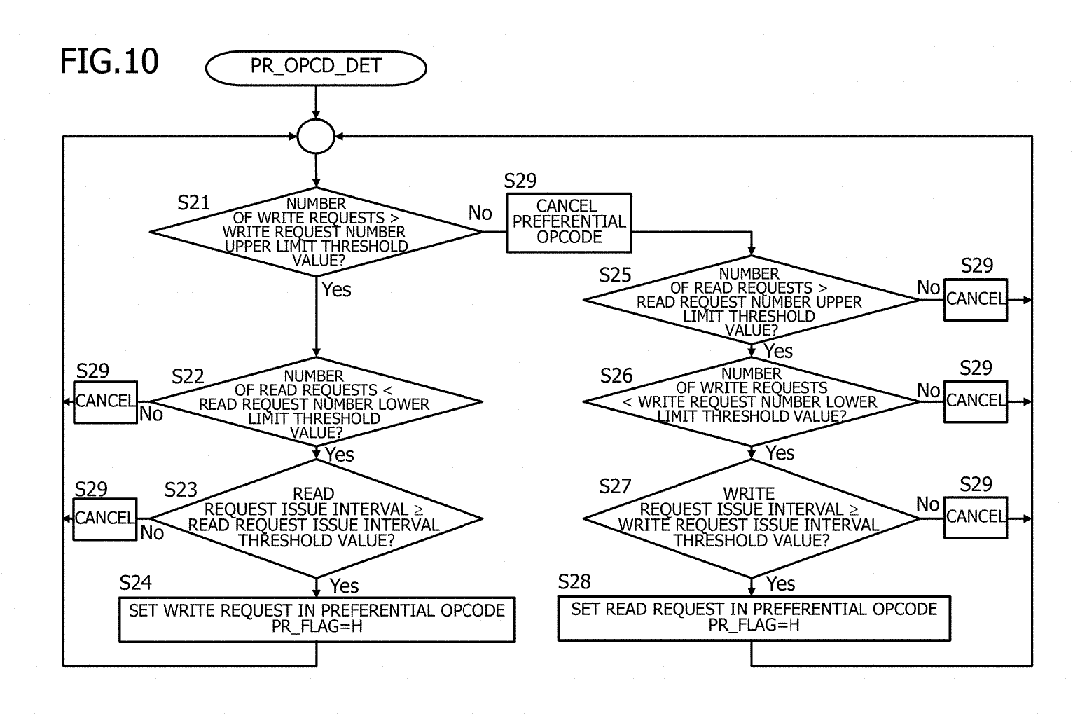

FIG. 10 is a flowchart illustrating the operation logic of the preferential opcode determination unit PR_OPCD_DET. When the number of write requests in the request queue is more than the upper limit threshold value of the number of write requests (YES in S21), the number of read requests in the request queue is less than the lower limit threshold value of the number of read requests (YES in S22), and the issue interval of the read request by the request selection circuit is not less than the read request issue interval threshold value (YES in S23), the preferential opcode determination unit PR_OPCD_DET sets the write request in the preferential opcode (S24). When the preferential opcode is set, a preferential flag PR_FLAG is set to an H level.

Conversely, When the number of read requests in the request queue is more than the upper limit threshold value of the number of read requests (YES in S25), the number of write requests in the request queue is less than the lower limit threshold value of the number of write requests (YES in S26), and the issue interval of the write request is not less than the write request issue interval threshold value (YES in S27), the preferential opcode determination unit PR_OPCD_DET sets the read request in the preferential opcode (S28). In this case as well, when the preferential opcode is set, the preferential flag PR_FLAG is set to the H level.

Further, when it is determined that any of S21, S22, and S23 described above is NO, the setting of the preferential opcode is canceled, and the level of the preferential flag PR_FLAG is changed to an L level. Similarly, when it is determined that any of S25, S26, and S27 described above is NO, the setting of the preferential opcode is canceled, and the level of the preferential flag PR_FLAG is changed to the L level. That is, when the preferential flag indicates the H level, the read or write request set in the preferential opcode is selected as a selection candidate in preference to the other opcodes by the request selection circuit except during the penalty period, and the selections of the other opcodes other than the preferential opcode are inhibited also during the penalty period. The request selection circuit selects the request that is enqueued earliest from among the selection candidates, and issues the selected request to the command issue unit.

The explanation of the meanings of the conditions described above is as follows. As indicated by the pattern PT11 in FIG. 4, in the case where the read request is previously issued, it is not possible to issue the subsequent write request before the lapse of its issue inhibition period due to the penalty. Consequently, when the next read request is enqueued in the request queue before the lapse of the issue inhibition period, the request selection circuit selects and issues the enqueued read request. As a result, the issue of the read request is repeated, and many write requests remain in the request queue. In this case, when the issue interval of the read request is long, the frequency of issue of the read request is low, the write request in the request queue is not issued during the issue interval, the frequency of issue of the request is reduced, and the request issue throughput is reduced.

In order to detect this situation (first state), the preferential opcode determination unit PR_OPCD_DET determines whether or not the conditions in S21, S22, and S23 described above are satisfied. Note that, in the case where the issue interval of the read request in S23 is long, considering the restrictions of the penalty, there is a high probability that the number of read requests in S22 is not more than the lower limit threshold value. Accordingly, the condition in S22 may be omitted.

When the read request and the write request change places in the explanation of the meanings of the conditions described above, the meanings of the conditions in S25, S26, and S27 can be explained. Therefore, the explanation of the conditions in S25, S26, and S27 will be omitted.

When the conditions in S21, S22, and S23 are satisfied, the situation of the pattern PT11 in FIG. 4 is realized. Accordingly, the preferential opcode determination unit sets the write request in the preferential opcode that allows preferential issue. With this, the read request in the request queue is excluded from the issue candidate because the read request is different from the write request in the preferential opcode. At the same time, the issue of the write request is inhibited during the issue inhibition period serving as the penalty, and hence the issue of both of the read request and the write request is inhibited during the issue inhibition period. After the lapse of the issue inhibition period, the write requests in the request queue are consecutively issued as the request set in the preferential opcode in preference to the read request. With this, the number of write requests in the request queue is reduced, the above condition (e.g., S21) is eliminated, and hence the selection state in the preferential opcode is canceled.

Conversely, when the conditions in S25, S26, and S27 are satisfied, the read request is selected in the preferential opcode. With this, the write request in the request queue is excluded from the issue candidate. Consequently, similarly to the above case, the issue of both of the write request and the read request is inhibited during the issue inhibition period serving as the penalty, and the read request in the request queue is selected and issued in preference to the write request after the lapse of the issue inhibition period.

Request Selection Circuit

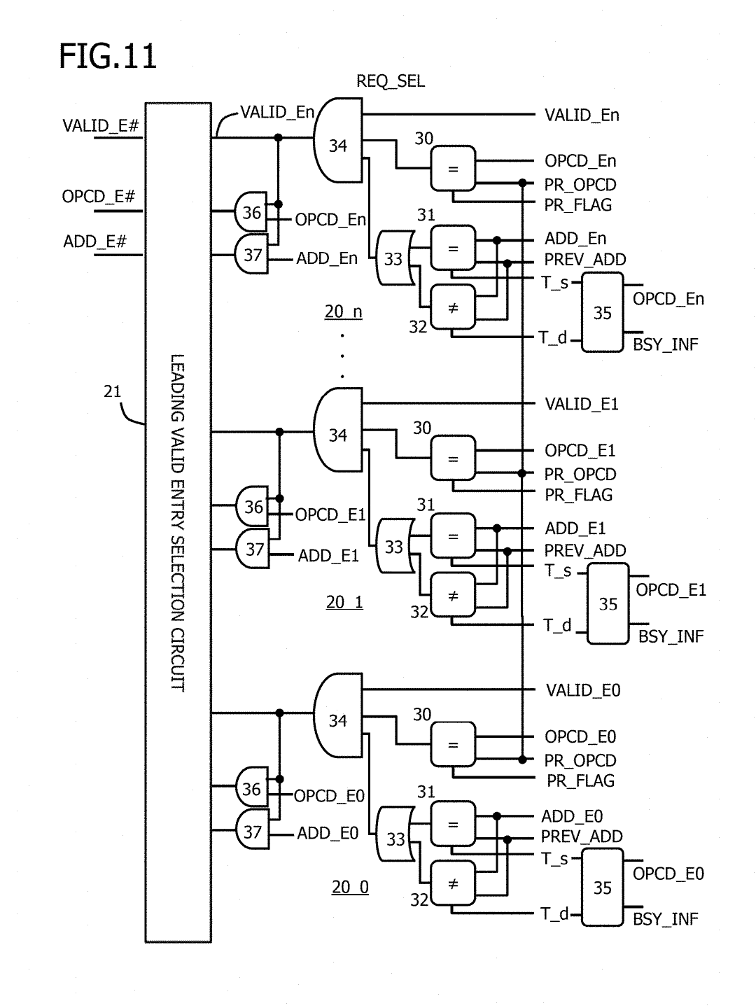

FIG. 11 illustrates an example of the request selection circuit controlled by the preferential opcode PR_OPCD. Each entry QUE_EN# of the request queue stores a valid signal VALID_E#, an opcode OPCD_E#, and an address ADD_E# (#=0, 1, . . . n) of the enqueued request. The request selection circuit REQ_SEL includes entry determination units 20_0, 20_1, . . . 20_n that determine whether or not the opcodes OPCD_E# and the addresses ADD_E# of the requests in the individual entries can be selected, and a leading valid entry selection circuit 21 that selects a leading entry having the request that is enqueued earliest from among the entries of the requests determined to be selection candidates in the entry determination units.

Among the individual entry determination units 20_0, 20_1, . . . 20_n, the entry determination unit 20_n (#=n), includes a preferential opcode match determination circuit 30 that outputs the result of a determination of whether or not the opcode OPCD_En of the request in the entry n matches the preferential opcode PR_OPCD in the case where the preferential flag is valid (PR_FLAG=H), and outputs a non-selection (L level) in the case where the preferential flag is invalid (PR_FLAG=L).

In addition, the entry determination unit 20_n includes a first busy signal generation circuit 31 that outputs a busy signal T_s for the same address in the case where the address ADD_En of the request in the entry n matches the address PREV_ADD of the previous request, and outputs the non-selection (L level) in the case where the address ADD_En of the request in the entry n does not match the address PREV_ADD of the previous request.

Similarly, the entry determination unit 20_n includes a second busy signal generation circuit 32 that outputs a busy signal T_d for different addresses in the case where the address ADD_En of the request in the entry n is different from the address PREV_ADD of the previous request, and outputs the non-selection (L level) in the case where the address ADD_En of the request in the entry n is not different from (is the same as) the address PREV_ADD of the previous request.

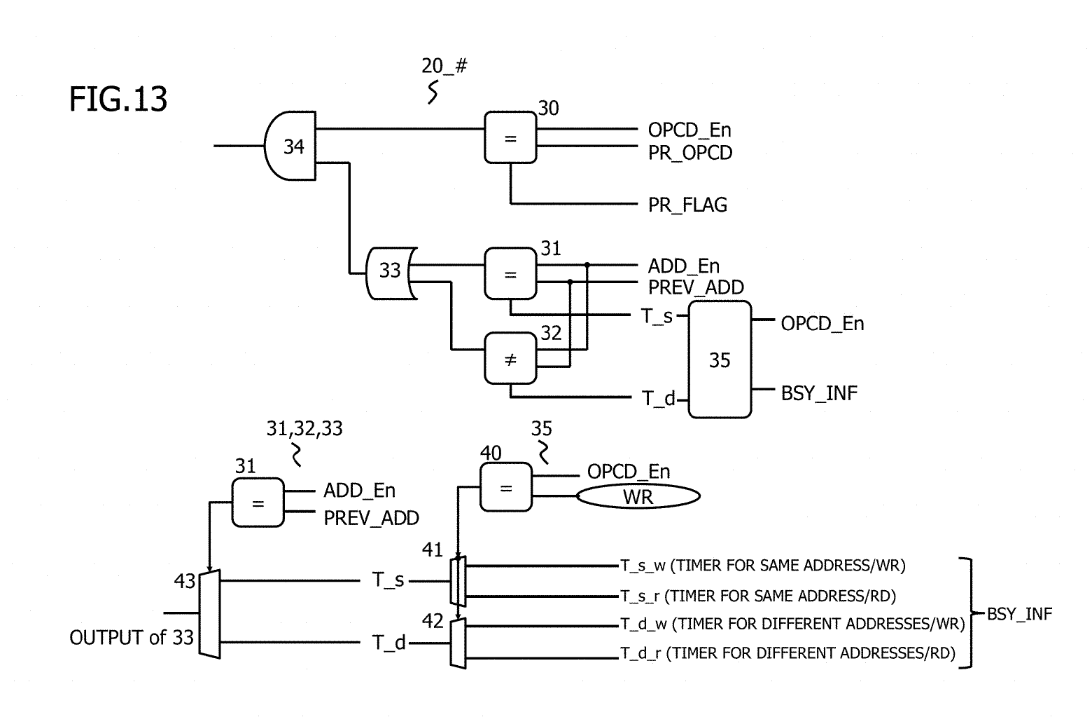

The busy signals T_s and T_d are selected from eight types of busy signals corresponding to the penalties illustrated in FIG. 2 by a busy signal selection circuit 35 based on the previous request opcode PREV_OPCD and the opcode OPCD_E# in the entry. See FIGS. 12 and 13.

In addition, the entry determination unit 20_n includes an OR gate 33 that outputs the logical OR of the outputs of the first and second busy signal generation circuits 31 and 32.

Further, the entry determination unit 20_n includes an AND gate 34 that receives a valid signal VALID_En of the entry, the output of the preferential opcode match determination circuit 30, and the output of the OR gate 33, and outputs the valid signal VALID_En in the case where each of the outputs of the preferential opcode match determination circuit 30 and the OR gate 33 indicates the H level (selection). Based on the valid signal VALID_En having passed through the AND gate 34, the opcode OPCD_En and the address ADD_En of the entry pass through AND gates 36 and 37, and are input to the leading valid entry selection circuit 21.

The configuration of each of the entry determination units 20_0 and 20_1 is the same as that of the entry determination unit 20_n.

The leading valid entry selection circuit 21 selects the request that is enqueued earliest from among the requests selected as the selection candidates in the individual entry determination units, and outputs (issues) the selected request to the command issue unit.

Next, the busy signal selection circuit 35 will be described. The busy signal selection circuit will be described after the description of the configuration of the busy information generation circuit BSY_INF_GEN. Further, the entry determination unit 20_# of the request selection circuit REQ_SEL will be described in detail.

FIG. 12 illustrates an example of the configuration of the busy information signal generation unit BSY_GEN in the busy information generation circuit BSY_INF_GEN. The busy information signal generation unit BSY_GEN includes eight timers TMR and four selectors 51 to 54. The timers TMR generate eight types of busy signals T_s_w_w, T_s_w_r, T_s_r_w, T_s_r_r, T_d_w_w, T_d_w_r, T_d_r_w, and T_d_r_r that transition to the L level during eight types of issue inhibition periods in response to a request issue signal ISS that is generated when the request (or command) is issued. The selectors 51, 52, 53, and 54 generate four types of busy signals T_s_w, T_s_r, T_d_w, and T_d_r that are selected from among eight types of busy signals based on whether the previous request is the read request or the write request based on the previous request opcode PREV_OPCD indicative of the type of the previous request. Specifically, a match determination circuit 50 outputs the H level and each of the selectors 51 to 54 selects the upper input when the previous request opcode PREV_OPCD indicates the write request WR, and the match determination circuit 50 outputs the L level and each of the selectors 51 to 54 selects the lower input when the previous request opcode PREV_OPCD does not indicate the write request WR.

FIG. 13 illustrates the entry determination unit 20_# and the busy signal selection circuit 35 of the request selection circuit. The entry determination unit 20_# is as illustrated in FIG. 11. The busy signal selection circuit 35 provided in the entry determination unit 20_# includes a match determination circuit 40 that determines whether or not the type (read or write opcode) of the request OPCD_En stored in the entry matches the write request WR, and selectors 41 and 42 each selecting one of the busy signal of the timer for WR and the busy signal of the timer for RD based on the output of the match determination circuit. The selector 41 selects the busy signal T_s for the same address for the write request WR or the read request RD, and the selector 42 selects the busy signal T_d for different addresses for the write request WR or the read request RD from among four types of busy signals T_s_w, T_s_r, T_d_w, and T_d_r generated by the busy information generation circuit in FIG. 12 based on the output of the match determination circuit 40 (the H level when OPCD_En=WR is satisfied and the L level when OPCD_En≠WR is satisfied).

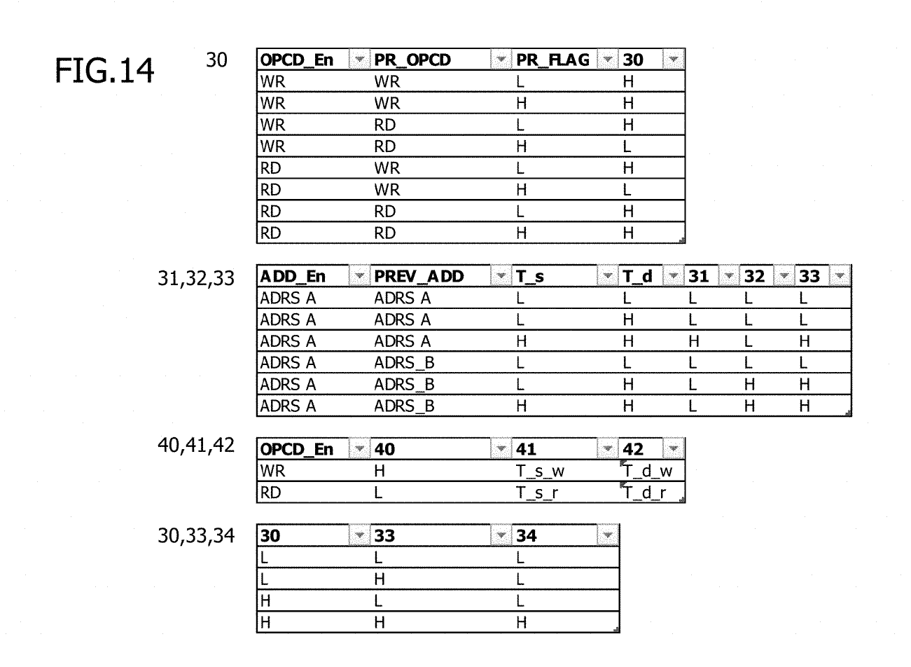

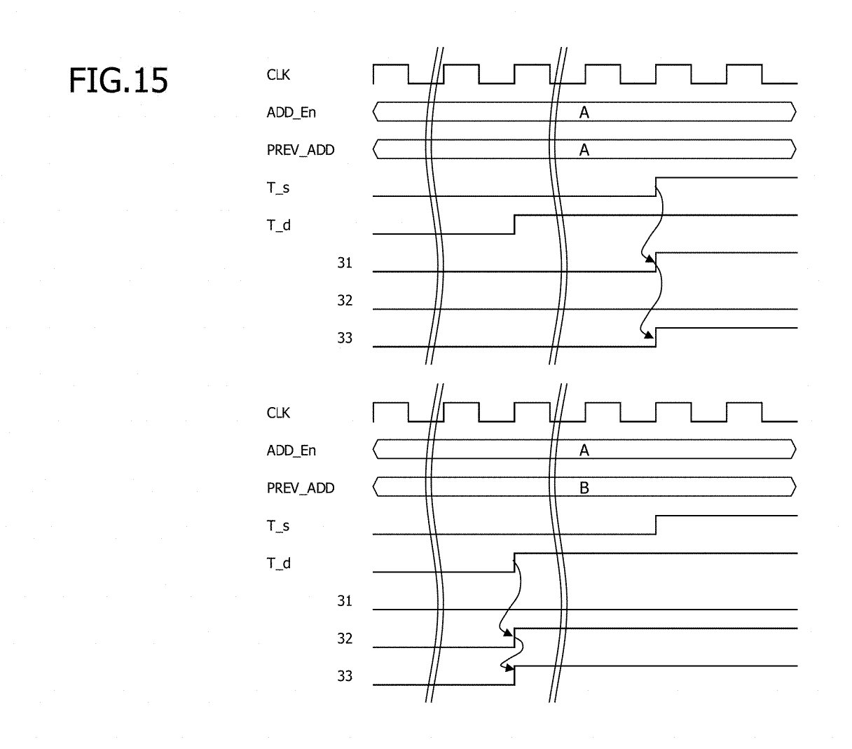

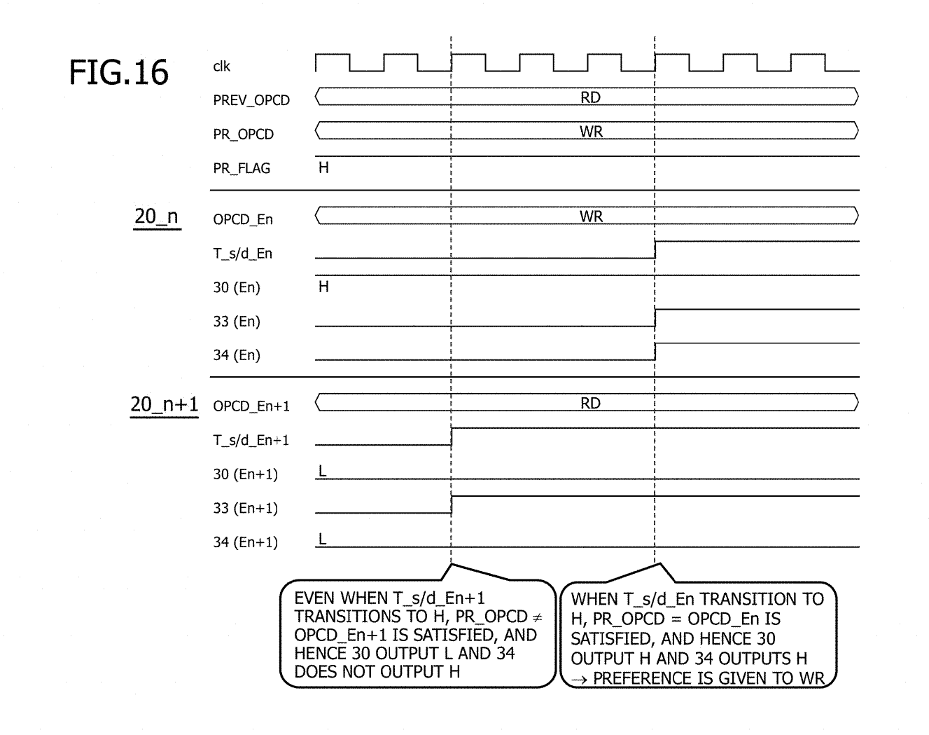

FIG. 14 illustrates truth tables of the individual logic circuits of the entry determination unit 20_#. Each of FIGS. 15 and 16 is a timing chart illustrating the operation of the entry determination unit 20_#.

As illustrated in FIG. 14, in the case where the preferential flag PR_FLAG indicates the H level (PR_FLAG=H), the preferential opcode match determination circuit 30 outputs the selection (H level) when the opcode OPCD_En of the entry matches the preferential opcode PR_OPCD, and outputs the non-selection (L level) when the opcode OPCD_En of the entry does not match the preferential opcode PR_OPCD. In the case where the preferential flag indicates the L level (PR_FLAG=L), the restriction of the preferential opcode is canceled, and hence the preferential opcode match determination circuit 30 outputs the selection (H level).

With regard to the first and second busy signal generation circuits 31 and 32 and the AND gate 33, the first busy signal generation circuit 31 outputs the busy signal T_s in the case where the address ADD_En of the entry matches the address PREV_ADD of the previous request, and forcibly outputs the non-selection (L level) in the case where the address ADD_En of the entry does not match the address PREV_ADD of the previous request. Conversely, the second busy signal generation circuit 32 outputs the busy signal T_d in the case where the address ADD_En of the entry does not match the address PREV_ADD of the previous request, and forcibly outputs the non-selection (L level) in the case where the address ADD_En of the entry matches the address PREV_ADD of the previous request.

FIG. 15 illustrates the signal waveforms of the outputs of the first and second busy signal generation circuits 31 and 32 and the OR gate 33 in the case where the address ADD_En of the entry matches the address PREV_ADD of the previous request (addresses are A) and in the case where the address ADD_En of the entry does not match the address PREV_ADD of the previous request (addresses are A and B). First, when the eight timers TMR in FIG. 12 respond to the issue signal ISS of the request or the command, the busy signals T_s and T_d are thereby caused to transition from the H level to the L level. The signals are narrowed down to the two busy signals T_s and T_d based on the combination of the previous request opcode and the opcode of the request in the entry, and hence the period of the L level of each of the busy signals T_s and T_d corresponds to the combination of the previous request opcode and the opcode of the entry.

As illustrated in FIG. 15, in the case where ADD_En=A and PREV_ADD=A are satisfied (addresses match each other), the output of the OR gate 33 is the busy signal T_s. On the other hand, in the case where ADD_En=A and PREV_ADD=B are satisfied (addresses are different from each other), the output of the OR gate 33 is the busy signal T_d. Accordingly, the first and second busy signal generation circuits 31 and 32 and the OR gate 33 select the busy signal T_s in the case where the address ADD_En of the entry matches the address PREV_ADD of the previous request, and select the busy signal T_d in the case where the address ADD_En of the entry does not match the address PREV_ADD of the previous request.

As illustrated on the left side of the circuit diagram of the busy signal selection circuit 35 in FIG. 13, the combination of the first busy signal generation circuit 31, the second busy signal generation circuit 32, and the OR gate 33 may be constituted by the match determination circuit 31 that determines the match between the address PREV_ADD of the previous request and the address ADD_En, and a selector 43 that selects T_s or T_d according to the result of the match determination. The output of the selector 43 matches the output of the OR gate 33.

FIG. 14 illustrates the truth table of the match determination circuit 40 and the selectors 41 and 42 in the busy signal selection circuit 35. Further, FIG. 14 illustrates the truth table of the preferential opcode match determination circuit 30, the OR gate 33, and the AND gate 34.

FIG. 16 illustrates the signal waveforms indicative of the operations of the preferential opcode match determination circuit 30, the OR gate 33, and the AND gate 34. FIG. 16 illustrates an example in which the preferential opcode PR_OPCD is set to the write request WR. In addition, FIG. 16 illustrates the signal waveforms of the entry En in the case where the previous request opcode PREV_OPCD does not match the opcode OPCD_En of the entry (PREV_OPCD=RD, OPCD_En=WR), and the signal waveforms of the entry En+1 in the case where the previous request opcode PREV_OPCD matches the opcode OPCD_En of the entry (PREV_OPCD=RD, OPCD_En+1=RD). Note that the busy signal switches between T_s and T_d depending on whether or not the addresses match each other but, in FIG. 16, the busy signals are indicated by T_s/d_En and T_s/d_En+1 irrespective of the match or the mismatch between the addresses.

In the entry determination unit 20_n of the entry En, the previous request opcode PREV_OPCD=RD is different from the opcode OPCD_En of the entry=WR, and hence a busy signal T_s/d_En having the long issue inhibition period is selected. In addition, the opcode OPCD_En of the entry matches the preferential opcode PR_OPCD (OPCD_En=PR_OPCD=WR), and hence the output of the preferential opcode match determination circuit 30 is the selection (H level), and the AND gate 34 outputs the selection (H level) when the busy signal T_s/d_En transitions from the L lever to the H level after the issue inhibition period. The H level of the output of the AND gate 34 is a selection signal for selecting the opcode OPCD_En and the address ADD_En at the AND gate 36 and 37 so that the opcode OPCD_En (WR) becomes a selection candidate in the leading valid entry selection circuit 21 in FIG. 11.

With the above operations, the write request WR is set in the preferential opcode, and the write request WR in the entry of the request que matches the write request WR in the preferential opcode, and hence the write request WR becomes a selection candidate when the busy signal changes from L level to H level due to the issue inhibition period being elapsed.

On the other hand, in the entry determination unit 20_n+1 of the entry En+1, the previous request opcode PREV_OPCD=RD matches the opcode OPCD_En+1 of the entry=RD, and hence a busy signal T_s/d_En+1 having the short issue inhibition period is selected. In addition, the opcode OPCD_En+1 of the entry does not match the preferential opcode PR_OPCD (OPCD_En+1≠PR_OPCD), and hence the output of the preferential opcode match determination circuit 30 is the non-selection (L level), and the AND gate 34 outputs the non-selection (L level) even after the busy signal T_s/d_En+1 transitions to the H level after the issue inhibition period. The L level of the output of the AND gate 34 is a non-selection signal for not selecting the opcode OPCD_En+1 and the address ADD_En+1 at the AND gate 36 and 37 so that the opcode OPCD_En+1 (RD) does not become a selection candidate in the leading valid entry selection circuit 21 in FIG. 11

With the above operations, the read request RD in the entry does not match the write request WR in the preferential opcode, and hence the read request RD is kept in the non-selection state not only when the busy signal is at the L level and also after the busy signal transitions to the H level due to a lapse of the issue inhibition period. In FIG. 4, PT12 shows the above operations. Assuming the write request WR is set to the preferential opcode after the clock cycle CK0. The read request RD is not issued at CK7 due to the preferential opcode being the write request WR, but the write requests WR are issued at CK8-CK11 after a lapse of the issue inhibition period tRW-s due to the write request WR being set as the preferential opcode. No request is issued in the corresponding issue inhibition period, and a first request being set as the preferential opcode is issued in preference to a second request different from the first request after a lapse of the corresponding issue inhibition period.

### Second Embodiment

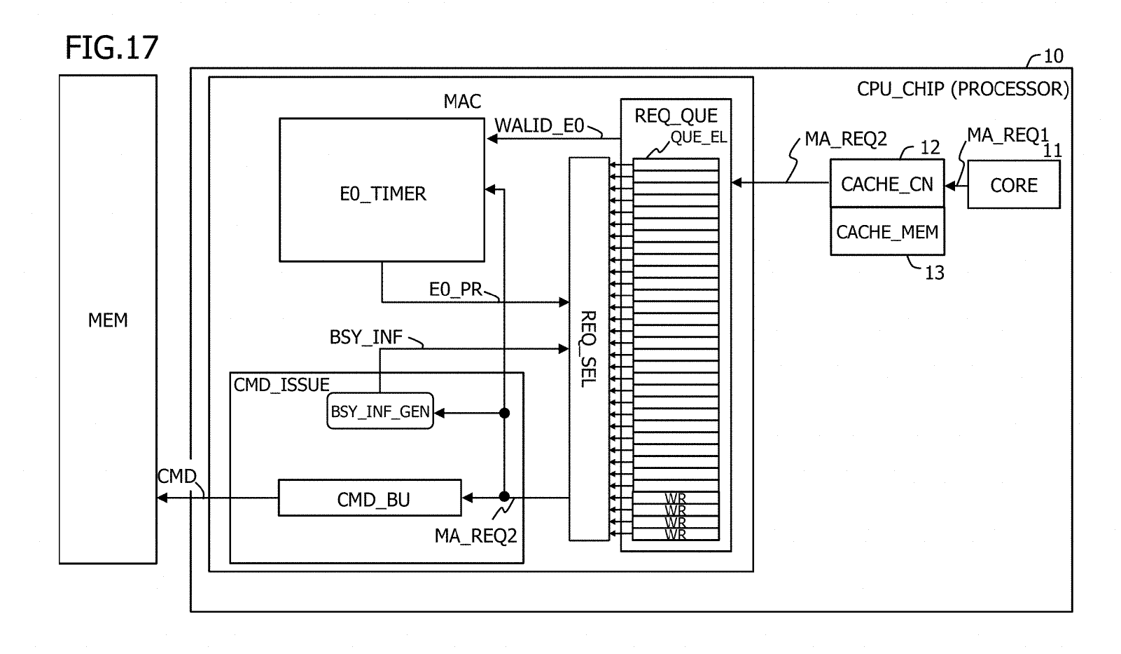

FIG. 17 illustrates the configuration of the processor in a second embodiment. The processor in FIG. 17 includes a head entry timer circuit E0_TIMER that generates a head entry preferential signal E0_PR instead of the preferential opcode generation circuit PR_OPCD_GEN in the processor in FIG. 5.

It is assumed that, similarly to the case in FIG. 3, write requests WR are accumulated in a predetermined number of entries from the head entry in the request queue in FIG. 17, and read requests RD are consecutively enqueued and issued at a low frequency.

The head entry timer circuit E0_TIMER includes a timer that starts to count the number of clocks when the request is entered in the head entry from the request queue REQ_QUE. When the timer reaches a predetermined threshold value and fires, the head entry timer circuit E0_TIMER generates a head entry preferential signal E0_PR (=H level) for preferentially issuing the request in the head entry. The head entry preferential signal E0_PR is reset to the L level when the request in the head entry is issued by the request selection circuit. In addition, the timer is reset and starts to count the number of clocks when the request is entered in the head entry.

The head entry preferential signals E0_PR are supplied to the entry determination circuits 20_# of all of the entries except the head entry E0 in the request queue and, when each head entry preferential signal E0_PR is set to the H level, the issue of the requests in all of the entries except the head entry E0 is inhibited. As a result, the request selection circuit preferentially issues the request in the head entry. For example, in the situation like the pattern PT11 in FIGS. 3 and 4, the write request WR in the head entry E0 is not issued for a long time period and remains in the request queue. In such a case, the head entry timer circuit E0_TIMER detects that the write request WR in the head entry E0 remains for a long time period, and causes the head entry preferential signal E0_PR to transition to the H level. As a result, the write request WR in the head entry is issued and, thereafter, a plurality of the write requests remaining in the request queue for a long time period are issued consecutively, and a state in which the request issue throughput is reduced is eliminated.

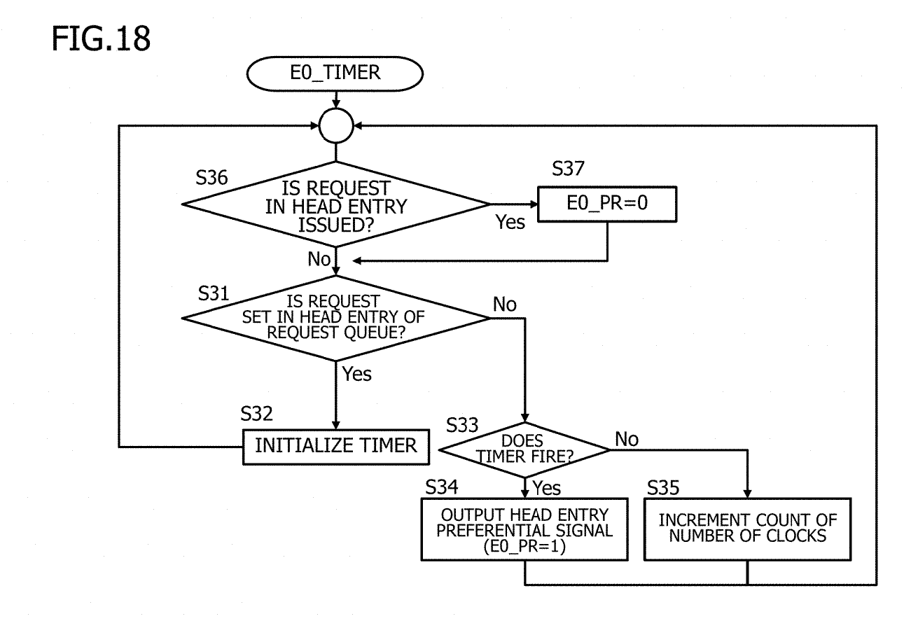

FIG. 18 illustrates a flowchart illustrating the operation of the head entry timer circuit E0_TIMER. First, when the head entry timer circuit detects that the request is set in the head entry QUE_EN in the request queue REQ_QUE by using the valid signal VALID_E0 of the head entry (YES in S31), the head entry timer circuit initializes the timer (S32), and the timer then counts the number of clocks. Subsequently, in the head entry timer circuit, the timer continues to count the number of clocks (S35) until the count value of the timer reaches a fire value (NO in S33).

On the other hand, when the count value of the timer reaches the fire value (YES in S33), the head entry preferential signal E0_PR is caused to transition to the H level (E0_PR=1) (S34). Thereafter, when the head entry timer circuit detects the issue of the request in the head entry by using the memory access request MA_REQ2 issued by the request selection circuit REQ_SEL (YES in S36), the head entry timer circuit resets the head entry preferential signal E0_PR to the L level (E0_PR=0) (S37). Further, when the request is newly set in the head entry (YES in S31), the head entry timer circuit initializes the timer (S32).

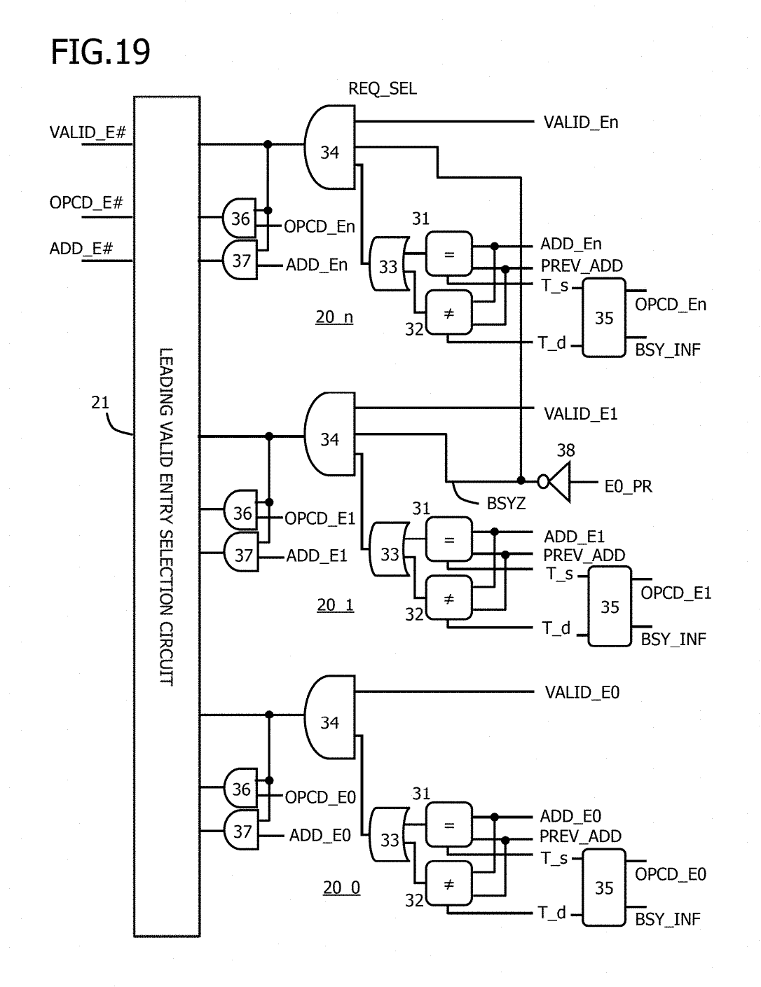

FIG. 19 illustrates an example of the request selection circuit controlled by the head entry preferential signal in the second embodiment. The configuration of the request selection circuit is different from the configuration in FIG. 11 in that a head entry busy signal BSY2 obtained by inverting the head entry preferential signal E0_PR in an inverter 38 is input to the AND gate 34, instead of using the preferential opcode match determination circuit 30 that determines whether or not the opcode matches the preferential opcode. The other configuration is the same as that in FIG. 11.

When a threshold time corresponding to the fire value elapses after setting the request in the head entry of the request queue, the head entry timer circuit causes the head entry preferential signal E0_PR to transition to the H level (E0_PR=H). As a result, the head entry busy signals BSY2 (L level) are input to the AND gates 34 of all of the entries except the head entry E0, and the issue of the requests in all of the entries except the head entry E0 is forcibly inhibited. With this, the request in the head entry E0 that has remained for a long time period is issued. When the request in the head entry is issued, the request of the same type in the subsequent entry is selected and issued prior to the request of a different type after the issue inhibition period by the penalty, and a situation in which the request issue throughput is reduced is eliminated.

As described above, according to the present embodiment, the memory access controller eliminates the situation in which the request of which issue is inhibited during the issue inhibition period for the penalty to the previous request remains in the request queue for a long time, and the request issue throughput is reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing unit comprising:
a processing unit;
a cache control unit that, in respond to a memory access from the processing unit, issues a request for the memory access in a case where data of an access destination is not stored in a cache memory; and
a memory access controller that includes a request queue in which the request is enqueued, and a request selection unit which selects a request from among requests enqueued in the request queue and issues the selected request to a memory, wherein
after issue of a previous request in the request queue, the request selection unit inhibits, during an issue inhibition period corresponding to the issued previous request, issue of a subsequent request corresponding to the issue inhibition period, and
the request selection unit issues a second request in preference to a first request in a case where the requests in the request queue are in a first state, the first request being one of a read request and a write request in the request queue, and the second request being a request in the request queue which is different from the first request.

2. The arithmetic processing unit according to claim 1, wherein
the first state is a state in which a frequency of issue of the first request to the memory is not less than a reference frequency, and the number of the second requests in the request queue is not less than a reference number.

3. The arithmetic processing unit according to claim 2, wherein
the memory access controller further includes:
a busy signal generation unit which monitors the request selected and issued by the request selection unit, and generates a busy signal which inhibits selection of the request during the issue inhibition period; and
a preferential opcode generation unit which monitors the request enqueued in the request queue and the request selected and issued by the request selection unit, and in the case where the request in the request queue is in the first state, sets, to the second request, a preferential opcode which allows the second request to be issued in preference to the first request, and
the request selection unit inhibits issue of the request in the request queue during the issue inhibition period based on the busy signal, and further inhibits issue of the request in the request queue which has an opcode different from the preferential opcode after a lapse of the inhibition period.

4. The arithmetic processing unit according to claim 3, wherein
the preferential opcode generation unit cancels the setting of the preferential opcode in a case where the first state is eliminated.

5. The arithmetic processing unit according to claim 2, wherein
the first state corresponds to a case where the number of the first requests in the request queue is less than a lower limit value, the number of the second requests in the request queue is more than an upper limit value, and an issue interval of the first request is not less than an issue interval threshold value.

6. The arithmetic processing unit according to claim 1, wherein
during the issue inhibition period, the request selection unit inhibits the issue of the subsequent request which is accumulated in the request queue and corresponds to the issue inhibition period, and after the issue inhibition period lapses, the request selection unit issues, in preference to the first request, the second request of which issue inhibition period has elapsed and which is enqueued earliest.

7. The arithmetic processing unit according to claim 1, wherein
the first state is a state in which a request is set in a head entry of the request queue and remains in the head entry for longer than a predetermined time from the setting of the request in the head entry.

8. The arithmetic processing unit according to claim 6, wherein
the memory access controller further includes:
a busy signal generation unit which monitors the request selected by the request selection unit, and generates a busy signal which inhibits issue of the request during the issue inhibition period; and
a head entry timer unit which monitors the request set in the head entry of the request queue and the request selected and issued by the request selection unit, and generates a head entry preferential signal which inhibits issue of requests in all entries except the head entry in the case where the request in the request queue is in the first state, and
the request selection unit inhibits the issue of the request in the request queue during the issue inhibition period based on the busy signal, and inhibits the issue of the requests in all of the entries except the head entry in the request queue based on the head entry preferential signal after a lapse of the inhibition period.

9. The arithmetic processing unit according to claim 8, wherein
the head entry timer unit resets the head entry preferential signal when the request in the head entry is issued.

10. The arithmetic processing unit according to claim 9, wherein
the head entry timer unit includes a timer which is reset when a request is set in the head entry, and generates the head entry preferential signal in a case where a count value of the timer exceeds the predetermined time.

11. A memory access controller comprising:
a request queue in which a request for a memory access is enqueued, the enqueued request for a memory access being issued by a processing unit; and
a request selection unit which selects a request from among requests enqueued in the request queue and issues the selected request to a memory, wherein
after issue of a previous request in the request queue, the request selection unit inhibits, during an issue inhibition period corresponding to the issued previous request, issue of a subsequent request corresponding to the issue inhibition period, and
the request selection unit issues a second request in preference to a first request in a case where the requests in the request queue are in a first state, the first request being one of a read request and a write request in the request queue, and the second request being a request in the request queue which is different from the first request.

12. A method of controlling an arithmetic processing unit including a processing unit, a cache control unit that, in respond to a memory access from the processing unit, issues a request for the memory access in a case where data of an access destination is not stored in a cache memory, and a memory access controller that includes a request queue in which the request is enqueued, and a request selection unit which selects a request from among requests enqueued in the request queue and issues the selected request to a memory, the method including
after issue of a previous request in the request queue, the request selection unit inhibiting, during an issue inhibition period corresponding to the issued previous request, issue of a subsequent request corresponding to the issue inhibition period, and
the request selection unit issuing a second request in preference to a first request in a case where the requests in the request queue are in a first state, the first request being one of a read request and a write request in the request queue, and the second request being a request in the request queue which is different from the first request.
